(19) United States
(12) Patent Application Publication
(10) Pub. No.: US 2003/0016383 A1
(43) Pub. Date: Jan. 23, 2003

(54) Internet receiver scanner

(76) Inventors: Jerlyn R. Culp, Fort Collins, CO (US); Gordon R. Nuttall, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/911,211

(22) Filed: Jul. 23, 2001

(51) Int. Cl. B41J 1/00; B41B 1/00; B41F 1/00; G06K 1/00; G06F 15/00

(52) U.S. Cl. 358/1.15

(57) ABSTRACT

System and method for scanning an image via an Internet receiver. A scanner may be linked to, or housed within, a set-top device or a display device or Internet appliance. The scanner automatically detects the image and acquires the image in electronic format. A control module for the Internet receiver is preferably embodied in computer readable program code stored on computer readable storage media. The computer readable program code may comprise program code for receiving the image in electronic format from the scanner; and program code for performing at least one function with the image in electronic format via the Internet receiver.

### FIELD OF THE INVENTION

The invention generally pertains to scanners, and more specifically, to systems and methods for scanning an image via an Internet receiver.

### BACKGROUND OF THE INVENTION

The Internet has developed as a widely used medium for communicating and sharing information and visual images with others via Internet web pages and email. Relatively inexpensive digital cameras, scanners, and electronic processing facilities have made it increasingly more convenient to share images via the Internet. For example, new parents may post pictures of their newborn baby on their Internet web site. As another example, a family may share genealogy research (e.g., photos, copies of birth certificates, immigration records, etc.) with other family members at their Internet web site. Likewise, friends and family members may email vacation photos to one another; a homeowner may email sketches illustrating their remodeling ideas to a contractor for a cost estimate; etc.

Until recently, viewing an Internet web site or sending and receiving email typically required a personal computer (PC). With the advent of Internet receivers that are readily connected to a standard television (TV), access to the Internet is now readily available to subscribers (e.g., via Microsoft Corporation's WebTV® or UltimateTV®, America Online, Inc.'s AOL-TV®, etc.) who do not even own or know how to use a PC. However, merely having access to the Internet does not necessarily allow the subscribers to share their own photos or other images with others over the Internet, either by posting images on an Internet web site or by sending the same via email.

One solution is to have these images converted to electronic format, for example, using a digital camera or scanner and a PC. Although PCs, scanners, etc., are typically available at many professional copy and print shops, it may be inconvenient to take the images to a professional copy and print shop for processing. In addition, sharing photos or other images is often a personal experience, which may deter some subscribers from using the services of a professional copy and print shop.

Another solution is to attach a stand-alone scanner to the Internet receiver itself, much like a conventional PC peripheral may be attached to a PC. However, installing and setting up such conventional “PC-like” devices to an Internet receiver can be a daunting task for those who are unfamiliar with the setup and operation of these devices and the required software.

### SUMMARY OF THE INVENTION

System for scanning an image via an Internet receiver may comprise a scanner linked to the Internet receiver. The scanner automatically detects the image and acquires the image in electronic format. A control module for the Internet receiver is preferably embodied in computer readable program code stored on computer readable storage media. The computer readable program code may comprise program code for receiving the image in electronic format from the scanner; and program code for performing at least one function with the image in electronic format via the Internet receiver.

Also disclosed is a method for scanning an image via an Internet receiver that may comprise the steps of: automatically detecting the image, automatically acquiring the image in electronic format, and performing at least one function with the image in electronic format via the Internet receiver.

### BRIEF DESCRIPTION OF THE DRAWINGS

Illustrative and presently preferred embodiments of the invention are illustrated in the drawings, in which:

FIG. 1 is a high level diagram illustrating the components of one embodiment of a scanner for an Internet receiver;

FIG. 2 is a front, plan view illustrating an embodiment of the scanner housed in a “set-top” device;

FIG. 3 is a front, plan view illustrating an embodiment of the scanner housed in a display device;

FIG. 4 is a process flow diagram illustrating the various components of one embodiment of a scanner for an Internet receiver and the interaction therebetween;

FIG. 5 illustrates an exemplary interface for setting up the scanner for the Internet receiver;

FIG. 6 illustrates an exemplary interface for configuring the scanner for the Internet receiver; and

FIG. 7 is a flow chart illustrating an embodiment of a method for scanning an image via an Internet receiver.

### DESCRIPTION OF PREFERRED EMBODIMENTS

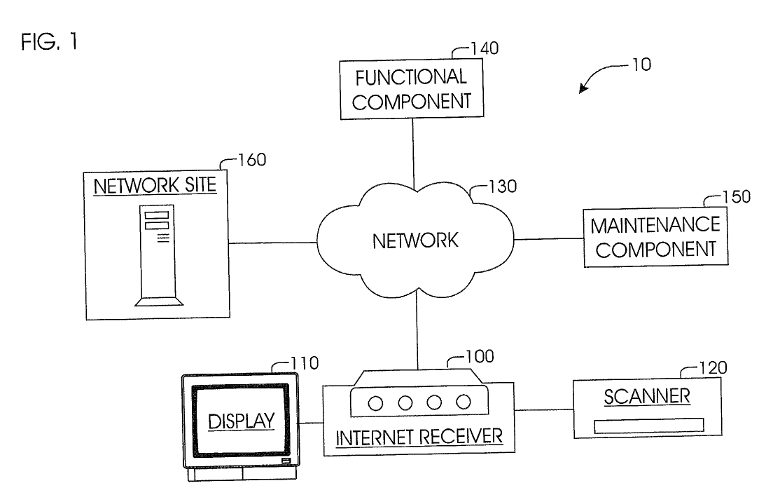

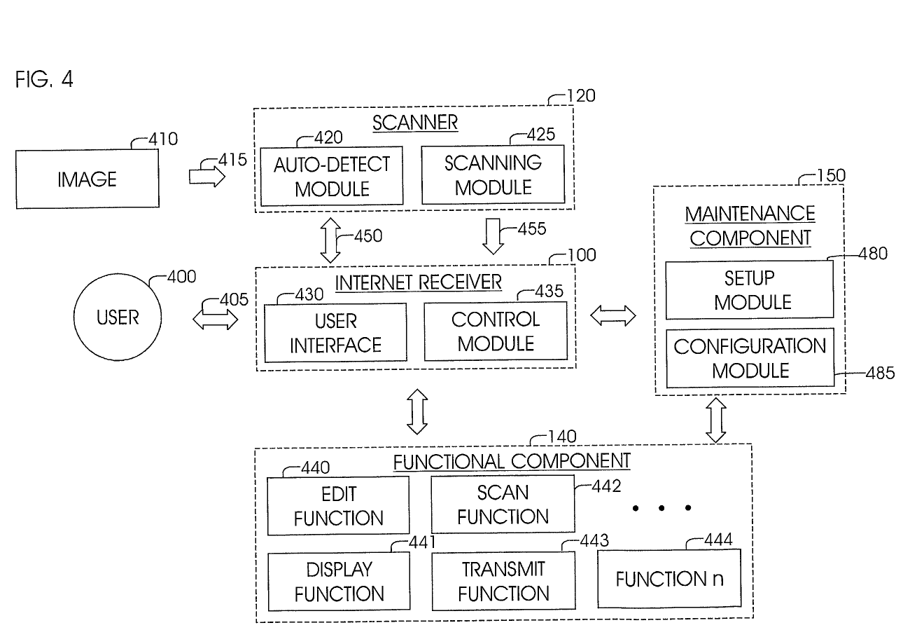

System 10 for scanning an image 410 (FIG. 4) via an Internet receiver 100 (FIG. 1) is shown and described herein as it could be used to share, archive, etc., images on the Internet (generally, network 130). Briefly, Internet receivers 100 are widely available for connection to a standard television (TV), and for use with subscription services, such as WebTV® and other such services. Use of an Internet receiver 100 with one of these subscription services allows the subscriber to communicate and share personal and other types of information with others via the Internet 130 without the need for, or understanding of, a separate personal computer (PC). For example, the subscriber may view pictures of geographically distant family members received via email or by visiting a personal Internet web site (e.g., network site 160) where the pictures are posted. However, the subscriber may desire to also send pictures via their Internet receiver 100, without having to use a PC, or without having to attach a stand-alone scanner to their Internet receiver 100.

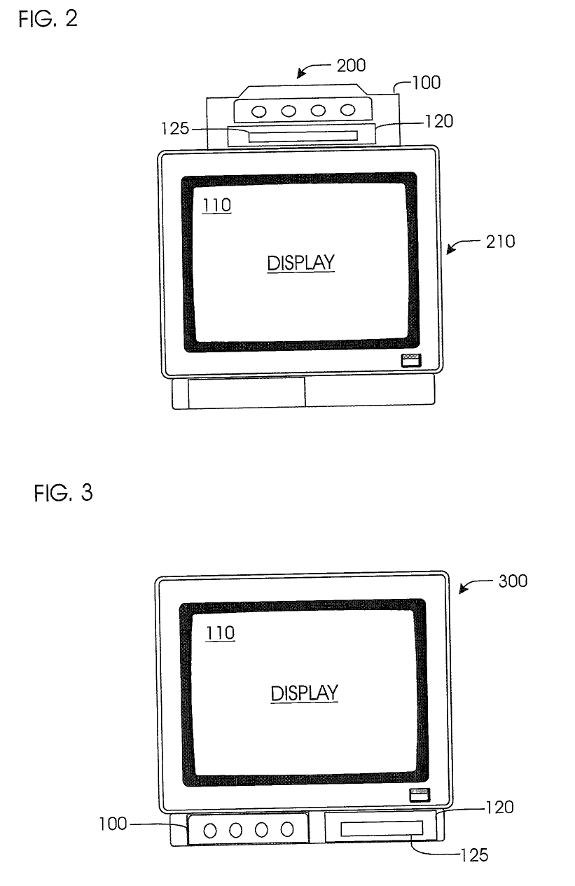

According to the teachings of the invention, the system 10 for scanning an image 410 via an Internet receiver 100 may comprise a scanner 120 linked to the Internet receiver 100. Preferably, the scanner 120 may be readily installed and set up with minimal effort. For example, the scanner 120 may be physically installed in the housing of a set-top device 200 (FIG. 2) for use with a standard TV 210. Or for example, the scanner 120 may be physically installed in the Internet appliance 300 (FIG. 3). Once physically installed, preferably the scanner 120 may be automatically set up and configured for use with, or operation via, the Internet receiver 100. The scanner 120 may be used to automatically detect the image 410 and acquire the image 410 in electronic format. A control module 435 (FIG. 4) for the Internet receiver 100 is preferably embodied in computer readable program code stored on computer readable storage media. The computer readable program code may comprise program code for receiving the image 410 in electronic format from the scanner 120; and program code for performing at least one function with the image 410 in electronic format via the Internet receiver 100.

The system 10 may be operated as follows to scan an image 410 via the Internet receiver 100. The user 400 (FIG. 4) may place an image 410 (e.g., a photograph, a 35 mm slide, rewritable nonvolatile memory, etc.) adjacent or into a receiving device 125 (FIG. 2 and FIG. 3) of the scanner 120. The scanner 120 may automatically detect the image 410. For example, a mechanical switch or an electronic or photo sensor may detect the presence of the image 410 at the receiving device 125. The scanner 120 may acquire the image 410 in electronic format. For example, the scanner 120 may scan a photograph or read data from rewritable nonvolatile memory. At least one function may be performed with the acquired image 410 in electronic format. For example, the image 410 may be edited or re-touched (e.g., to crop, to reduce “red-eye”, to correct for poor lighting, to add a border, to resize, etc.). As another example, the image 410 may be displayed on the user's TV or display 110. As yet another example, the image 410 may be transmitted via the network 130, such as by email to another user, posted to an Internet web page (e.g., at network site 160), etc. Preferably, the system 10 may be configured to automatically perform one or more pre-selected functions.

According to the invention, Internet users having access to the Internet 130 via an Internet receiver 100 and a subscription service (e.g., WebTV®, or the like) may scan images 410 to share with others via the Internet 130, without the need for, or understanding of a PC. Instead, the scanner 120 may be used with the Internet receiver 100 itself. In addition, the scanner 120 of the invention may be readily installed, set up and configured, with minimal and/or no technical understanding of PCs and PC peripherals. Preferably, the invention also may be housed together with the Internet receiver 100 in the set top box 200, or as part of the display device (e.g., a self-contained Internet appliance 300), thus consuming little or no extra shelf space.

Having generally described a system 10 and method for scanning an image 410 via an Internet receiver 100, systems and methods of the invention will now be described in further detail.

FIG. 1 is a high level diagram illustrating one embodiment of a system 10 for scanning images 410 (FIG. 4) via an Internet receiver 100 (FIG. 1). The Internet receiver 100 is preferably linked to a display 110 (e.g., a standard television display), and to a network 130 (e.g., the Internet). According to the invention, a scanner 120 is linked to the Internet receiver 100, through which it may also be linked to the display 110 and the network 130. Various other components, such as the functional component 140 and the maintenance component 150 of the invention, are preferably embodied in computer readable program code and may reside on the network 130 (e.g., at one or more network sites). A network site 160, such as an Internet web site, is also illustrated in FIG. 1, as it may be used according to the teachings of the invention, as described in more detail below.

The scanner 120 is preferably a compact, self-contained device that may be readily physically installed for use with the Internet receiver 100, as explained in more detail below with respect to FIG. 2 and FIG. 3. For example, the scanner 120 may be housed similar to a floppy disk drive that may be readily received within an opening or bay formed in a set top device 200 or the housing of the display 110 itself (e.g., Internet appliance 300).

The scanner 120 preferably has a receiving device 125 (see, e.g., FIG. 2 and FIG. 3), wherein the image 410 may be placed adjacent to, or within the receiving device 125, and automatically detected and acquired by the scanner 120. As such, the scanner 120 may be powered down when it is not in use (e.g., in “sleep” mode), and automatically powered up (e.g., “awakened”) on an “as needed” basis. For example, a 35 mm slide may be acquired in electronic format when it is contained in a slide holder that is placed adjacent to the receiving device 125. Or for example, a photograph may be sensed when it is held adjacent the receiving device 125, and automatically drawn into the scanner 120 (e.g., similarly to an envelop receiver at an ATM machine) to be acquired by the scanner 120. Or for example, the receiving device 125 may be a drawer or tray similar to a compact disc (CD) tray that may slide out, on which the user 400 may place the image 410 that is to be scanned. Or for example, the receiving device 125 may comprise a contact for linking to rewritable nonvolatile memory (e.g., the memory card of a digital camera) to acquire the image 410 stored thereon. Other embodiments of the scanner 120 are also contemplated as being within the scope of the invention.

Any suitable Internet receiver 100 may be used according to the teachings of the invention. Furthermore, the term “Internet receiver” is used herein to describe a device primarily for readily accessing a network such as the Internet through a subscription service or the like. The Internet receiver 100 may be a set top device (e.g., 200), or a fully integrated device (e.g., 300). Although the invention is preferably for use with the Internet, the Internet receiver 100 is not limited to devices strictly for use with the Internet. It is also understood that the display 110 may be any suitable display, such as, but not limited to, a standard analog or digital television, a liquid crystal display (LCD), computer monitor, etc.

The scanner 120 may be linked to the Internet receiver 100 by any suitable means (e.g., audio/visual (AV) jack, digital jack, small computer systems interface (SCSI), universal serial bus (USB), etc.), now known or later developed. In one embodiment, the scanner 120 may be linked to the Internet receiver 100 via a unidirectional link, such as a digital jack. In such an embodiment, the data (e.g., the image 410 in electronic format) may be uploaded to a network site 160, wherein computer readable program code may be provided at the network site 160 for editing, or performing other functions with the acquired image 410 in electronic format. In another embodiment, the scanner 120 may be linked to the Internet receiver 100 via a bi-directional link, such as a USB connection. For example, during installation and set up, the Internet receiver 100 may be configured with the USB class device, USB stack, and browsing capabilities. In addition, for example, the operational program code and other configuration information may be downloaded from a network site 160. The URL identifying where the operational program code resides on the network 130 may be downloaded to the Internet receiver 100 prior to or during configuration thereof. Such a bi-directional link enables the user 400 to perform at least one function to the image 410 prior to acquiring a final scan of the image 410.

It is understood that although the network 130 is preferably the Internet, the network 130 may be any suitable network (LAN, WAN, the Internet, etc.). Likewise, the Internet receiver 100 may be linked to the network 130 via any suitable means (e.g., modem, T-1, digital subscriber line (DSL), infrared, etc.), through yet other devices (e.g., routers, hubs), other networks (e.g., LAN, Intranet), etc. Indeed, the Internet receiver 100 may be linked to the network 130 through a combination of networks. For example, the Internet receiver 100 may be linked to the Internet via an internal LAN.

FIG. 2 is a front, plan view illustrating an embodiment of the scanner 120 as it may be housed in a “set-top” device 200 together with the Internet receiver 100. In this embodiment, the Internet receiver 100 may be housed as a stand-alone device or set-top device 200 that may be positioned on or near a TV 210. As such, the scanner 120 may be purchased separately and inserted into a bay formed within the set-top device 200. The scanner 120 and the Internet receiver 100 may comprise suitable mating connectors for linking to the Internet receiver 100, and for linking to a power source. Preferably, the connectors are such that the user 400 is not required to separately connect the Internet device 100, the scanner 120, and the power source (not shown). That is, preferably, as the scanner 120 is received within the bay, or otherwise physically installed in the housing of the set-top device 200, the connector(s) on the scanner 120 make contact, connect with, or otherwise links to, the mating connectors within the housing of the set-top device 200. Alternately, the scanner 120 may be physically installed therein during manufacture of the set-top device 200.

FIG. 3 is a front, plan view illustrating another embodiment of the scanner 120 as it may be housed together with the Internet receiver 100 in a self-contained “Internet television” or Internet appliance 300 (i.e., a device dedicated to email, Internet access, and possibly other limited functions). As such, the scanner 120 may be purchased separately and received within a bay formed in the Internet appliance 300. Again, the scanner 120 and the Internet receiver 100 may comprise suitable mating connectors for linking to the Internet receiver 100, and for linking to a power source. Preferably, the connectors are such that the user 400 is not required to separately connect the Internet device 100, the scanner 120, and the power source (not shown). That is, preferably, as the scanner 120 is received within the bay, or otherwise physically installed in the housing of the Internet appliance 300, the connector(s) on the scanner 120 make contact, connects with, or otherwise links to, the mating connectors within the housing of the Internet appliance 300. Alternately, the scanner 120 may be physically installed therein during manufacture of the Internet appliance 300.

It is understood that the scanner 120 may be physically installed in any suitable manner in the set top device 200 in FIG. 2, or the Internet appliance 300 in FIG. 3. For example, a face-plate (not shown) may be removed from the set top device 200 or the Internet appliance 300, exposing an opening or bay formed therein in which the scanner 120 may be received within. Or for example, a lid may be opened, and the scanner 120 “dropped” into place therein. Or for example, a drawer may slide out from the set top device 200, or Internet appliance 300, in which the scanner 120 may be placed, and the drawer closed to physically install the scanner 120 therein. It is further understood that, although in a preferred embodiment, the connection between the scanner 120 and the Internet receiver 100 is made between mating connectors, any suitable link may be used, including cabling, hard wiring, infrared (IR), etc.

It is also understood that the exemplary embodiments of the scanner 120 housed in the set-top device 200 in FIG. 2, and in the Internet appliance 300 in FIG. 3 are merely illustrative of arrangements contemplated according to the teachings of the present invention, and are not intended to limit the scope of the invention thereto. Other embodiments are also contemplated, such as, but not limited to, the scanner 120 housed in an “expansion” device (i.e., a device provided specifically for connecting other devices to the Internet receiver 100), in TV 210 for use with the set top box 200, etc.

The system control is preferably embodied in firmware and/or software (i.e., computer readable program code), generally referred to as the control module 435, the user interface 430, the functional component 140, and the maintenance component 150. It is understood that the computer readable program code may be stored in any suitable computer readable storage media at the Internet receiver 100, and/or elsewhere on the network 130.

FIG. 4 is a process flow diagram illustrating the various components of one embodiment of a scanner 120 for an Internet receiver 100 and the interaction therebetween according to the teachings of the invention. The user 400 may place an image 410 adjacent or into a receiving device 125 (e.g., FIG. 2) of the scanner 120. An auto-detect module 420 of the scanner 120 may automatically detect the image 410. For example, a mechanical switch or an electronic or photo sensor may detect the presence of the image 410 at the receiving device 125. The detected image 410 may be acquired 415 in electronic format by a scanning module 425 of the scanner 120. For example, the scanner 120 may scan a photograph or read data from rewritable nonvolatile memory. The acquired image 410 in electronic format may be received by the control module 435 of the Internet receiver 100. For example, the image 410 may be received by the Internet receiver 100 via a bi-directional link 450, or via a unidirectional link 455.

In any event, at least one function may be performed with the acquired image 410 in electronic format via the functional component 140. For example, the user 400 via the user interface 430 may edit or retouch the image 410 (e.g., crop, reduce “red-eye”, correct for poor lighting, add a border, resize, etc.) using an edit function 440 of the functional module 140. As another example, the image 410 may be displayed on the display 110 according to the display function 441 of the functional module 140. In another example, a final scan of the image 410 may be acquired according to the scan function 442. As yet another example, the image 410 may be transmitted via the network 130, such as by email to another user, posted to an Internet web page (e.g., at network site 160), etc., according to the transmit function 443 of the functional module 140. The functional module 140 may also comprise other functions (e.g., Function n 444), that may be performed automatically, manually, or a combination thereof based on the configuration of the system 10.

Preferably a maintenance component 150 is also provided, which may comprise a setup module 480 and a configuration module 485. The setup module 480 may comprise program code for setting up and configuring the scanner 120 for use with the Internet receiver 100. For example, the setup module may comprise program code for receiving configuration meta data from the user 400 or for configuring the scanner 120 for use with the Internet receiver 100 according to default configuration meta data. The setup module 480 may also install and/or upgrade any drivers or other control software, as required. The configuration module 485 may comprise a database with default configuration meta data for configuring the scanner 120 for use with the Internet receiver 100, as explained in more detail below with respect to FIG. 6. The maintenance component 150 may be accessed for initial setup and configuration of the scanner 120 for use with the Internet receiver 100. In addition, the maintenance component 150 may also be accessed to update the program code as needed, to change or reconfigure the scanner 120 for use with the Internet receiver 100, etc.

Preferably the user interface 430 and the control module 435 of the Internet receiver 100, and the functional component 140 and the maintenance component 150 are embodied in computer readable program code stored on computer readable storage media residing at, or associated with, the Internet receiver 100. It is understood that the drivers and/or control software may be downloaded from the network 130 “on demand”, or on an “as-needed” basis to perform the scan operation, image editing, etc., so as to conserve memory at the Internet receiver 100. Also preferably, the control module 435 includes only minimal functionality so as not to consume the storage media associated with the Internet receiver 100, and so that the program code can be readily updated. Instead, the functionality is primarily part of the functional component 140 and is stored elsewhere (e.g., on the network 130). Likewise, the set up, configuration, and maintenance features are part of the maintenance component 150 and are also stored elsewhere (e.g., on the network 130). The auto-detect module 420, and or the scanning module 425 may be hardware and/or computer readable program code.

It is understood that the computer readable program code may reside on the Internet receiver 100, elsewhere on the network 130 (e.g., at a server), or a combination thereof. In addition, control software may also be included on the scanner itself (e.g., as an application specific integrated circuit (ASIC), in the scanner's non-volatile memory as a program file, etc.). Preferably, however, only minimal program code is stored on storage media associated with the Internet receiver 100 and/or the scanner 120. As such, the program code, or portions thereof, may be readily updated without the user having to take any action to upgrade the program code. As such, the latest version of the program code may preferably always be accessed.

It is also understood that the components shown in FIG. 4 are merely illustrative of the various aspects of the invention and need not be characterized as such. For example, the control module 435, the functional component 140, and the maintenance component 150 may be combined, or may be further subdivided into separate modules or routines and/or subroutines. In addition, the computer readable program code may comprise more components than those shown in FIG. 4. Furthermore, the computer readable program code may be a stand-alone application, a plug-in module, otherwise combined with an existing application and/or operating system, etc.

Preferably, the scanner 120 may be readily setup for use with the Internet receiver 100. That is, the scanner 120 is physically installed, for example, as discussed above with respect to FIG. 2 and FIG. 3. Preferably, upon physical installation thereof, the control module 435 automatically configured the scanner 120 for use with the Internet receiver. For example, the installation status may be displayed for the user 400 via the user interface 430.

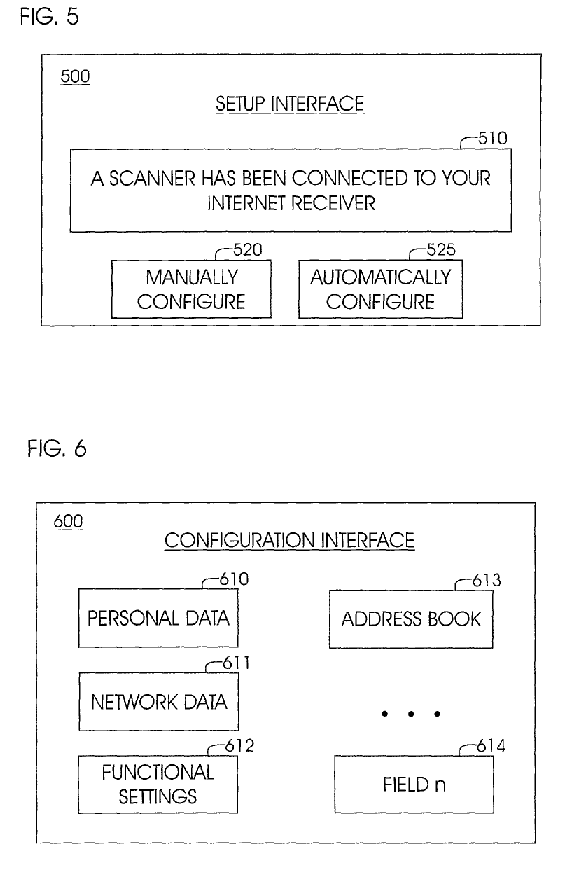

FIG. 5 illustrates an exemplary setup interface 500 that the user 400 may interact with to setup the scanner 120 for use with the Internet receiver 100. Upon physical installation of the scanner 120, a status window 510 may communicate to the user 400 that a scanner has been detected as connected to or otherwise linked to the Internet receiver 100. In addition, the user 400 may be given an option between manual configuration (e.g., button 520) or automatic configuration (e.g., button 525) of the scanner 120 for use with the Internet receiver 100. The user 400 may make the desired selection, for example, using a keyboard, mouse, etc. Where the user selects automatic configuration 525, the control module 435 may be automatically configured using default configuration information. The user 400 may also be given the opportunity to edit or change some or all of the default configuration information. Where the user selects manual configuration 520, the user 400 may be prompted to enter various configuration information via the user interface 430.

FIG. 6 illustrates an exemplary configuration interface 600 that the user 400 may interact with to manually configure the scanner 120 for use with the Internet receiver 100. The user 400 may provide personal data 610. For example, the user 400 may enter their name, address, etc., for registration or other informational purposes. The user 400 may also provide network data 611. For example, the user 400 may enter the URL of their favorite photo editing Internet web site, the URL of their favorite genealogy Internet web site, the URL of their favorite photo album archives Internet web site, the URL of their personal home page, etc. In addition, the user 400 may also provide information such as user IDs, pass codes, restrictions, etc. The user may also provide functional settings 612. For example, the user 400 may specify that images 410 detected and acquired by the scanner 120 are to be automatically included as an attachment to an email. Or for example, the user 400 may specify that images 410 detected by the scanner are to be initially acquired in draft quality and displayed for the user 400 on display 110 with an editing toolbar. Or for example, the user 400 may specify that the images 410 detected and acquired by the scanner 120 are to be automatically transmitted to a particular Internet web page. Alternatively, the user 400 may specify that a menu of functional options be displayed when an image 410 is detected by the scanner 120. The user may also provide address book information 613. For example, the user may provide personal email addresses or personal Internet web pages for directing the acquired images 410 thereto.

It is understood that the user may provide more or less meta data for configuration than that which has been discussed above, and that the meta data is not limited to the categories shown in FIG. 6. For example, the user 400 may provide any suitable information (e.g., Field n 614) for configuring the scanner 120 for use with the Internet receiver 100. In addition, default information may also be provided, for example, where the user 400 does not provide some or all of the configuration data, and may be changed by the user 400. Such default information may include, but is not limited to, URLs for photo editing Internet web pages (e.g., that are owned by the vendor, or according to a business partnership or advertising arrangement), email addresses imported from the user's “address book” database, etc.

It is also understood that the interfaces shown in FIG. 5 and FIG. 6 are merely illustrative of exemplary embodiments of interfaces 430 that may be used to setup and configure the scanner 120 for use with the Internet receiver 100. Other embodiments are also contemplated according to the teachings of the invention.

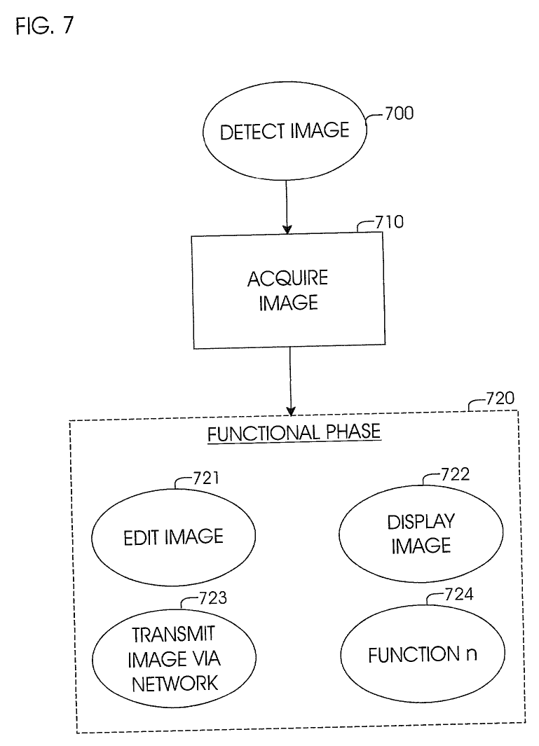

FIG. 7 is a flow chart illustrating an embodiment of a method for scanning an image 410 via an Internet receiver 100. In step 700, the image 410 is automatically detected by the scanner 120 (e.g., by auto-detect module 420). For example, the user 400 may place an image 410 (e.g., a photograph, a 35 mm slide, rewritable nonvolatile memory, etc.) adjacent or into the device 125 of the scanner 120, and a mechanical switch or an electronic or photo sensor may detect the presence of the image 410. In step 710, the scanner 120 may acquire the image 410 in electronic format. For example, the scanner 120 may scan a photograph or read data from rewritable nonvolatile memory. Preferably, the image 410 is automatically required. That is, the user 400 is not required to activate the scanning module 425 by pressing a scan button, or otherwise. Instead, the scanning module 425 automatically acquires the image 410 upon the presence thereof being detected in step 700. In the functional phase 720, at least one function may be performed with the acquired image 410 in electronic format. For example, the image 410 may be edited or re-touched (e.g., cropped, to reduce “red-eye”, to correct for poor lighting, to add a border or call-out, to resize, etc.), in step 721. As another example, the image 410 may be displayed on the user's TV or display 110, in step 722. As yet another example, the image 410 may be transmitted via the network 130, such as by email to another user, posted to an Internet web page (e.g., at network site 160), etc., in step 723. Or any one or more other functions (e.g., Function n 724) may be performed in step 720.

It is understood that the method illustrated in FIG. 7 is merely exemplary of the invention and is not intended to limit the scope thereof. In other embodiments, additional steps may be included, such as receiving a final scan of the image 410 after performing at least one function during the functional phase 720. In addition, in one embodiment, at least one function may be manually selected. Or in another embodiment, the system 10 may be configured to automatically perform one or more pre-selected functions during the functional phase 720. Other embodiments are also contemplated as being within the scope of the invention.

It should be noted that the teachings of the invention may be utilized in any of a wide range of Internet receivers 100 now known in the art or that may be developed in the future. Accordingly, the present invention should not be regarded as limited to any particular Internet receiver 100. It should also be noted that while an Internet receiver 100 is shown and described herein as it could be used with a conventional television, the display 110 is not limited to any particular type or style of display. Indeed, the invention disclosed herein could be used with any type of display 110 for use with an Internet receiver 100. Consequently, the present invention should not be regarded as limited to use with the Internet receiver 100 and the display 110 shown and described herein.

What is claimed is:

1. A method for scanning an image via an Internet receiver, comprising:
automatically detecting said image;
automatically acquiring at least a portion of said image in electronic format; and
performing at least one function with said image in said electronic format via said Internet receiver.

2. A method as in claim 1, wherein performing said at least one function comprises automatically performing at least one pre-selected function.

3. A method as in claim 1, further comprising manually selecting said at least one function.

4. A method as in claim 1, further comprising acquiring a final scan of said image after performing said at least one function.

5. A method as in claim 1, wherein performing said at least one function comprises performing at least one of the following functions: editing said image in said electronic format, displaying said image in said electronic format, and transmitting said image in said electronic format over a network.

6. A system for scanning an image via an Internet receiver, comprising:
a scanner linked to said Internet receiver, said scanner automatically detecting said image and acquiring at least a portion of said image in electronic format;
a control module for said Internet receiver, comprising:
computer readable storage media;
computer readable program code stored on said computer readable storage media, comprising:
a) program code for receiving said image in said electronic format from said scanner; and
b) program code for performing at least one function with said image in said electronic format via said Internet receiver.

7. A system as in claim 6, wherein said scanner is linked to said Internet receiver via a unidirectional link.

8. A system as in claim 6, wherein said scanner is linked to said Internet receiver via a bi-directional link.

9. A system as in claim 6, wherein at least a portion of said scanner is housed together with said Internet receiver in a set-top device.

10. A system as in claim 6, wherein at least a portion of said scanner is housed together with said Internet receiver in a display device.

11. A system as in claim 6, further comprising program code for automatically setting-up said scanner for operation via said Internet receiver.

12. A system as in claim 6, wherein at least part of said computer readable program code is downloaded to said Internet receiver from a network site on an as-needed basis.

13. A system as in claim 6, wherein said computer readable program code resides at least in part at a network site to conserve memory at said Internet receiver.

14. A system as in claim 6, further comprising program code for pre-selecting said at least one function.

15. A system as in claim 6, further comprising program code for receiving a manual selection of said at least one function after said image is detected.

16. A system as in claim 6, wherein said program code for performing said at least one function comprises program code for performing at least one of the following functions: editing said image in said electronic format, displaying said image in said electronic format, and transmitting said image in said electronic format over a network.

17. A system as in claim 6, further comprising program code for acquiring a final scan of said image after said at least one function is performed.

18. A system as in claim 6, further comprising a maintenance component comprising program code for configuring said control module.

19. A system for scanning an image via an Internet receiver, comprising:
a scanner housed together with said Internet receiver for automatically detecting said image, and for automatically acquiring said image in electronic format;
a control module for receiving said image in said electronic format from said scanner, and for performing at least one function with said image in said electronic format via said Internet receiver.

20. A system as in claim 19, further comprising a maintenance module for setting up and configuring said scanner.
